(19) United States
(12) Patent Application Publication
(10) Pub. No.: US 2016/0205045 A1
(43) Pub. Date: Jul. 14, 2016

(54) APPARATUS AND METHOD FOR ARBITRATING BETWEEN MULTIPLE REQUESTS

(71) Applicant: ARM LIMITED, Cambridge (GB)

(72) Inventor: Andrew David TUNE, Sheffield (GB)

(21) Appl. No.: 14/596,316

(22) Filed: Jan. 14, 2015

(51) Int. Cl. H04L 12/935; H04L 12/931

(52) U.S. Cl. CPC H04L 49/30; H04L 49/503; H04L 49/508

(57) ABSTRACT

An apparatus is provided that includes switching circuitry having a plurality of source ports and a plurality of destination ports. The apparatus also includes arbitration circuitry for performing an arbitration operation on a plurality of requests presented at the plurality of source ports in order to determine, for at least one of the destination ports, one of the requests to be output from that destination port. The arbitration operation comprises applying a first arbitration policy in respect of requests presented by a first subset of the plurality of source ports, and a second arbitration policy in respect of requests presented by the plurality of source ports. The first arbitration policy is to reduce head-of-line blocking compared to the second arbitration policy. Consequently, it is possible to reduce head-of-line blocking while reducing the latency for delay intolerant requests presented at some of the source ports.

### BACKGROUND

2. Technical Field

The present technique is concerned with the field of switching, and in particular to an apparatus and method for arbitrating between multiple requests presented to switching circuitry.

2. Description of the Prior Art

In switching circuitries such as interconnects, a number of connected devices may exchange data with each other. For example, a source may transmit data to a destination via switching circuitry. The switching circuitry must therefore be able to connect pairs of devices together in order for a data exchange to take place.

In such circuitry, there may be contention between sources to reach destinations. In particular, it is common for a destination to be capable of only receiving data from one source at a time. Consequently, if multiple sources wish to transmit data to the same destination then it is necessary to perform arbitration in order to decide which source is allowed to transmit its data to the destination. Those sources that are not selected (the losing sources) are blocked and must wait until the winning source completes its transmission. If one of the losing sources has a queue of data that is to be sent to other destinations then this data will be delayed until the arbitration scheme selects that losing source to send its data to the contested destination, thereby unblocking it. This phenomenon, in which a queue of data is held up by the front data, is known as head-of-line blocking. Whilst head-of-line blocking could be alleviated by providing a mechanism to cancel some requests, rather than leaving them to wait, and employing a higher-level protocol to take necessary actions to re-transmit them if required, this would significantly increase complexity.

Head-of-line blocking can become worse when traffic is not uniformly random. For example, if the traffic is bursty such that one or more sources send a large number of transmissions to a particular destination in a short period of time, then this can cause more transmissions to be delayed and for those transmissions to be delayed for a longer period of time than when the traffic is uniformly random.

A previously proposed way of dealing with bursty traffic is by using virtual output queues. However, such a mechanism can require a significant increase in the size and power consumption of the switching circuitry.

Another previously proposed way of dealing with a busty traffic situation is to use an arbitration scheme that is exhaustive. An exhaustive arbitration scheme continues to select the same source as long as that source continues to supply data. When the source no longer has data to send, the arbitration scheme reconsiders which source to allow to transmit next. Sometimes, an exhaustive arbitration scheme may include some kind of starvation avoidance mechanism. In particular, if a first source has been continually transmitting data for a predefined period of time then another source may be given an opportunity to transmit, even if the first source still has data to send. A disadvantage of using exhaustive arbitration schemes is that time-sensitive data can be delayed.

It would therefore be desirable to deal with head-of-line blocking without a significant increase in circuitry size and without compromising sources that occasionally send time-sensitive information.

### SUMMARY

Viewed from a first aspect, there is provided an apparatus comprising: switching circuitry comprising a plurality of source ports and a plurality of destination ports; and arbitration circuitry to perform an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein said first arbitration policy is to reduce head-of-line blocking compared to said second arbitration policy.

Viewed from a second aspect, there is provided an apparatus comprising: switching means for performing switching between a plurality of source ports and a plurality of destination ports; arbitration means for performing an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein said first arbitration policy is to reduce head-of-line blocking compared to said second arbitration policy.

Viewed from a third aspect, there is provided a method of arbitrating at a switching circuitry comprising a plurality of source ports and a plurality of destination ports, the method comprising: performing an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein said first arbitration policy is to reduce head-of-line blocking compared to said second arbitration policy.

### BRIEF DESCRIPTION OF THE DRAWINGS

The present invention will be described further, by way of example only, with reference to embodiments thereof as illustrated in the accompanying drawings, in which:

FIG. 1 illustrates, schematically, the problem of head-of-line blocking with bursty traffic;

FIG. 2 illustrates, schematically, an apparatus in accordance with one embodiment;

FIG. 3A illustrates an example of arbitration circuitry in accordance with one embodiment;

FIG. 3B illustrates an example of arbitration circuitry in accordance with one embodiment;

FIG. 3C illustrates an example of arbitration circuitry in accordance with one embodiment;

FIG. 4 shows, schematically, an example of an interconnect in accordance with one embodiment; and

FIG. 5 shows, in flow chart form, a switching method in accordance with one embodiment.

### DESCRIPTION OF EXAMPLE EMBODIMENTS

Before discussing the embodiments with reference to the accompanying figures, the following description of embodiments and associated advantages is provided.

According to one aspect there is provided an apparatus comprising: switching circuitry comprising a plurality of source ports and a plurality of destination ports; and arbitration circuitry to perform an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein said first arbitration policy is to reduce head-of-line blocking compared to said second arbitration policy.

In accordance with the above, an arbitration operation that makes use of a first arbitration policy and a second arbitration policy is performed. The first arbitration policy is applied in respect of requests presented by a first subset of said plurality of source ports. For example, the first arbitration policy may not be applied in respect of all of the plurality of source ports. A second arbitration policy is applied in respect of requests presented by the plurality of source ports. Hence, two arbitration policies are applied in respect of the requests presented by some of the source ports, whilst one arbitration policy is applied in respect of requests presented by the other source ports. Note that although a first arbitration policy and a second arbitration policy are referred to here, there is no requirement that the arbitration policies are performed separately. In other words, there is no requirement that an intermediate set of results is obtained. In particular, the first arbitration policy and the second arbitration policy may be applied simultaneously or in parallel, or may be applied as a result of performing a single operation. In any event, the first arbitration policy is to reduce head-of-line blocking as compared to the second arbitration policy. Consequently, the first arbitration policy that considers head-of-line blocking is not applied in respect of request at some of the source ports.

The first subset of the plurality of source ports may exclude those source ports for which a low latency response is required. Accordingly, requests issued at those source ports may not be subject to the first arbitration policy and so it may be possible to transmit such requests to their destinations quicker than if the requests had been subject to the first arbitration policy that reduces head-of-line blocking.

The term “request” is typically used throughout this specification to refer to a communication from a source to a destination. Each communication may consist of one or more portions, and in one embodiment, each communication comprises a control portion and an optional accompanying data portion. However, the term is not limited to this, and may include any communication from a source to a destination.

The plurality of source ports may comprise a second subset, and the arbitration circuitry may apply the arbitration operation without applying the first arbitration policy to requests presented by the second subset. As a consequence of applying the arbitration operation without applying the first arbitration policy to requests presented by the second subset, it is possible to reduce a delay in handling the requests in the second subset as a consequence of the first arbitration policy arbitrating between such requests.

The second arbitration policy may be to reduce a latency of requests presented by said second subset of said plurality of source ports compared to requests presented by said first subset of said plurality of source ports. Consequently, requests that are presented by the second subset of the plurality of source ports may be responded to more quickly than requests presented by the first subset of said plurality of source ports. It may therefore be possible to inhibit head-of-line blocking for the first subset of the plurality of source ports for which head-of-line blocking is important to avoid. Meanwhile, the second subset of the plurality of source ports, which may be those source ports that are less prone to head-of-line blocking occurring or that are less tolerant to delay, may be handled separately by an arbitration policy that reduces delay.

The second arbitration policy may be selected from the group comprising: Least Recently Used, Round Robin, Weighted Round Robin, Pseudo Least Recently Used, and Oblivious Fair. It will be appreciated that other arbitration policies may also be used.

In some embodiments, said arbitration circuitry applies said first arbitration policy to produce a third subset of said plurality of source ports, wherein the third subset is a subset of the first subset; and said arbitration circuitry applies said second arbitration policy in respect of requests presented by said third subset of said plurality of source ports and in respect of requests presented by said second subset of said plurality of source ports. In such embodiments, the second arbitration policy is still applied in respect of requests presented by the plurality of source ports even though the second arbitration policy is only directly applied to some of the source ports. In particular, in such embodiments, the application of the first arbitration policy may produce an intermediate set of source ports, which are considered together with the second subset of the plurality of source ports when applying the second arbitration policy. Such an approach has the advantage that the second arbitration policy may be applied more quickly, since it may not be necessary to directly consider every single one of the plurality of source ports. If the second arbitration policy can be performed by directly considering a smaller number of ports, it may be possible to perform the second arbitration policy using a smaller number of comparisons and this may therefore require circuitry that is smaller and consumes less power than when the second arbitration policy directly considers all of the plurality of source ports. For example, the third subset may consist of a single source port. If the first subset comprises 10 source ports, and if the second subset comprises two source ports, then it is only necessary for the second arbitration policy to directly consider three source ports. Such an arbiter may be implemented using significantly less circuitry than an arbiter that must directly consider all 12 source ports.

The first arbitration policy may be exhaustive. Under normal circumstances, an exhaustive arbitration policy continues to accept requests from a source as long as that source provides requests.

Note that in an exhaustive arbitration policy, in response to a timeout, the arbitration policy may switch to being non-exhaustive until a predefined condition is met. For example, if a source continually presents requests an exhaustive arbitration policy may, after a period of time has lapsed, switch the source for which requests are being accepted. Such a technique can be used to avoid starvation in which the destinations are denied or starved of requests as a consequence of a single source continuing to present requests over a long period of time. The predefined condition may be as simple as the selection of a new source port. In other words, as soon as a new source port is selected, the policy can stop being non-exhaustive. Alternatively, the predefined condition may be such that the arbitration policy stops being exhaustive until such time as all of the source ports are able to carry out a single transmission each. Once the predefined condition is met, the arbitration policy can switch back to being exhaustive. Note that when the arbitration policy switches back to being exhaustive, it may not revert to accepting requests from the previously selected source port. In particular, if the arbitration policy switches to being non-exhaustive, a different source port may be selected. At that point, if the arbitration policy resumes being exhaustive, it may continue to except requests from the newly selected source port rather than the previously selected source port.

The first arbitration policy may give priority to the most recently used source port. Such a policy is an example of an exhaustive arbitration policy. In particular, provided that a given source port continues to present requests, the first arbitration policy will continue to select that particular source port (starvation avoidance mechanisms such as those previously discussed not withstanding).

If no request is presented at the most recently used source port, the first arbitration policy may select a source port fairly. Such fairness may be either weak or strong. As defined in The Principles and Practices of Interconnection Networks by Daily and Towels, Chapter 18.2, p 351-352, weak fairness means that every request is eventually served and strong fairness means that requesters will be served equally often. An example of a weakly fair arbiter can be found in US 2013/0318270. By selecting a source port fairly when no request is presented at the most recently used source port, a particular source is less likely to become permanently stalled as a consequence of never being selected by the first arbitration policy.

The first arbitration policy may select a source port fairly by using a policy from the group comprising: Most Recently Used, Pseudo Most Recently Used, Least Recently Used, Round Robin, Weighted Round Robin, Pseudo Least Recently Used and Oblivious Fair. Other arbitration policies will be known to the skilled person and may also be usable for the first arbitration policy.

In some embodiments, said arbitration circuitry applies a third arbitration policy to produce said fourth subset of said plurality of source ports, wherein the fourth subset is a subset of the second subset; and said arbitration circuitry applies said second arbitration policy in respect of requests presented by said fourth subset of said plurality of source ports and in respect of requests presented by said first subset of said plurality of source ports. In such embodiments, each of the source ports is subject to at least two arbitration policies as a consequence of applying the arbitration operation. Such an approach can be used in order to provide a finer grain control over which source port is selected to be the “winner” of the arbitration operation.

The arbitration circuitry may apply the second arbitration policy to a request presented by exactly one source port in said first subset and to a request presented by exactly one source port outside said first subset.

The arbitration circuitry may perform the arbitration operation using a matrix arbiter. A matrix arbiter may be used to determine, for example, the source port that has priority when there is contention between two source ports. Accordingly, when a plurality of source ports each have a request which needs to be transmitted to a particular destination, a matrix arbiter may be used in order to determine the source port that has priority. The values used in a matrix that is used to control such an arbiter may be updated every time an arbitration operation occurs. Accordingly, a matrix arbiter may be used to implement all of the arbitration policies used to carry out the arbitration operation. Furthermore, each of the arbitration policies may be performed substantially simultaneously as a consequence of using the matrix arbiter.

In other embodiments, the arbitration circuitry may comprise a first arbiter to apply said first arbitration policy and a second arbiter to apply said second arbitration policy. Such embodiments may be implemented using significantly less circuitry than is required for a matrix arbiter. Consequently the size of the circuitry and the power consumed by the circuitry may be reduced as compared to an embodiment using a matrix arbiter.

According to a second aspect there is provided an apparatus comprising: switching means for performing switching between a plurality of source ports and a plurality of destination ports; arbitration means for performing an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein said first arbitration policy is to reduce head-of-line blocking compared to said second arbitration policy.

According to a third aspect there is provided a method of arbitrating at a switching circuitry comprising a plurality of source ports and a plurality of destination ports, the method comprising: performing an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein said first arbitration policy is to reduce head-of-line blocking compared to said second arbitration policy.

Particular embodiments will now be described with reference to the figures.

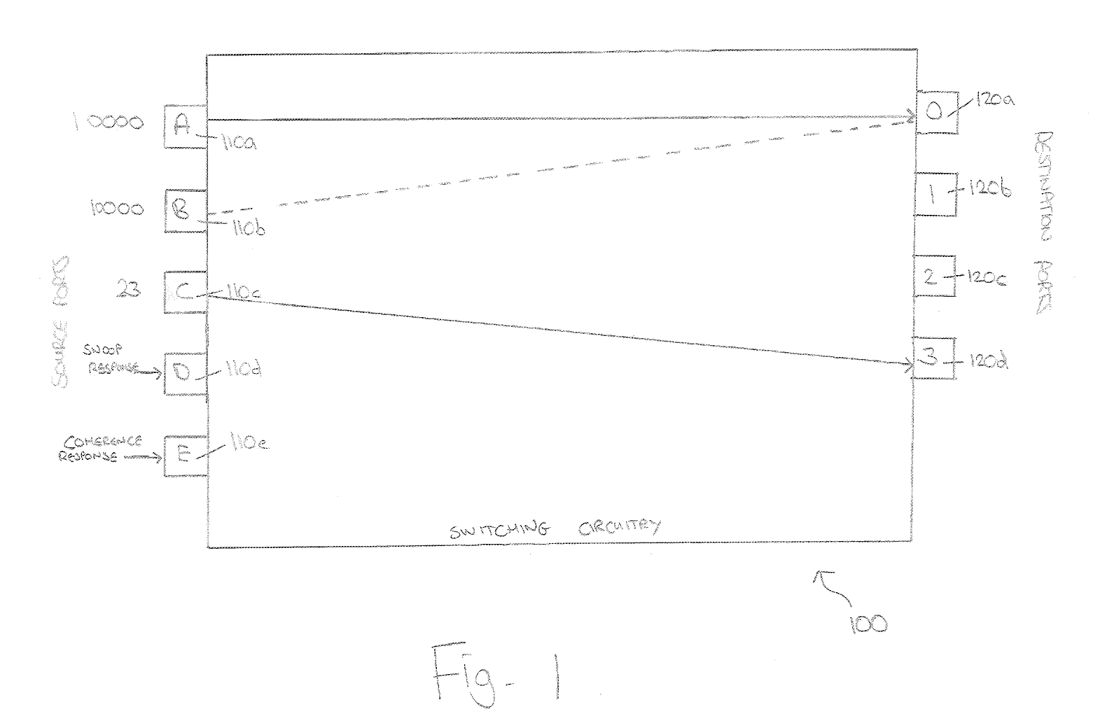

FIG. 1 illustrates a switching circuitry 100 and a scenario in which head-of-line blocking can occur with bursty traffic.

The switching circuitry 100 in FIG. 1 comprises a number of source ports 110a, 110b, 110c, 110d, and 110e together with a plurality of destination ports 120a, 120b, 120c, and 120d. The source ports may be connected to slave devices that return data from memory to master devices at the destination ports. In the embodiment shown in FIG. 1, a queue of requests is illustrated at source ports A 110a, B 110b, and C 110c. In particular, source port C 110c is transmitting to destination port 3 120d. Meanwhile, source ports A 110a and B 110b are attempting to transmit a request to destination port 0 120a. Source port A has succeeded as shown by the solid line in FIG. 1. However, source port B 110b is blocked as a consequence of not being able to transmit its request to destination port 0 by virtue of that destination port being engaged with source port A 110a. Head-of-line blocking occurs because at the end of the queue of requests which is to be transmitted by source port B 110b is a request that is to be transmitted to destination port 1 120b. Even though destination port 1 120b is currently unengaged, this request cannot be transmitted until the requests that are ahead of it, that are to be transmitted to destination port 0 120a, have been sent. However, these requests cannot be transmitted because destination port 0 120a is engaged as previously described. Hence, in this figure, head-of-line blocking is occurring.

With bursty traffic, using an arbitration policy such as Round Robin, in which each source port takes it in turn to transmit its next request, the head-of-line blocking is particularly problematic. In particular, the example illustrated in this embodiment, there will be consistent contention between source ports A and B while each of those source ports attempts to transmit their requests to destination port 0 120a. Once those requests have been successfully sent, however, each of the source ports A 110a and B 110b will then have contention with each other by virtue of attempting to transmit to the same destination port 1 120b. The initial contention between sources ports A and B for destination port 0 120a means that destination port 1 120b is starved of requests for an extended period of time, which may be undesirable.

In an alternative embodiment, an exhaustive arbitration scheme may be used. In such a scheme, all of the requests presented at source port A 110a are delivered until such time as source port A 110a has no more requests to be transmitted. At this time, a different source port may be selected for transmission of its requests. Head-of-line blocking is alleviated more quickly because the contention between source ports A and B 110a, 110b is resolved more quickly. This leads to a more efficient bandwidth use, since the source ports are blocked for less time.

However, such arbitration schemes are not always entirely beneficial. In the embodiment of FIG. 1, source port D is used to transmit snoop responses, which may occur in response to a snoop request. When a master wishes to access data where the most recent version of that data may be stored in a cache line of another master device, a snoop request may be sent to each of the master devices in order to determine whether the any of the caches at those master devices contains a more up-to-date version of the data than the memory. Each of the queried master devices then responds with a snoop response indicating whether the cache at that master device contains a more up-to-date version of the requested data or not. The original request for the data cannot be satisfied until such time as each of the master devices is interrogated and responds. Otherwise it is possible that an out-of-date version of the data will be obtained or that multiple different versions of the data will end up being stored in different caches. Consequently, it is necessary for snoop responses served at source port D 110d to be serviced quickly. Similarly, if a master device wants to write data that happens to be stored in a shared cache line of another master device then the master will attempt to acquire ownership of that cache line so that the write can be performed. The results of this attempt may be sent to the master device in the form of snoop responses. Again a snoop response can be time critical since, in order to avoid a lack of coherency, such a system may be unable to proceed until the master device has been instructed as to the result of its initial request. In some cases, coherency control circuitry may determine that it is not necessary to send a snoop request to a master device and may itself provide a coherency response in response to a snoop request. Again, a coherency response may be time critical.

However, with an exhaustive arbitration scheme, it is possible that individual requests (e.g. snoop requests, snoop responses, or coherency responses) will be delayed. For example, if the exhaustive arbitration scheme exhausts all the requests provided at source port A 110a, and then exhausts all of the requests at source port B 110b, then a large number of requests must be sent before a snoop response presented at source port D 110d can be serviced.

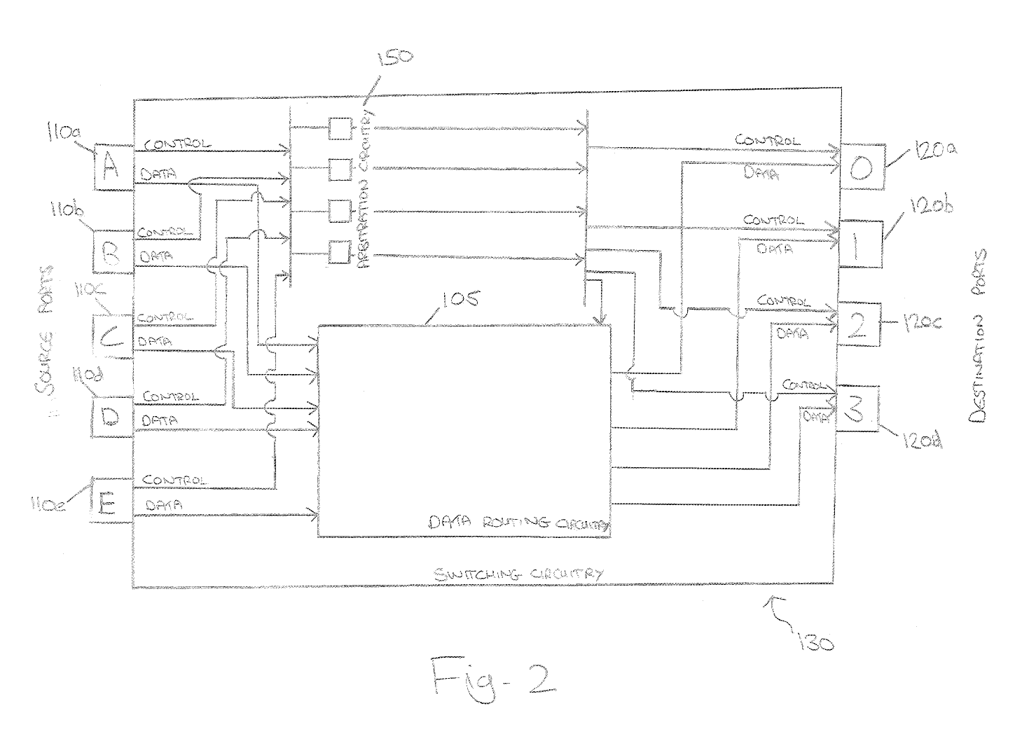

FIG. 2 illustrates an example of switching circuitry 130 in accordance with one embodiment that includes functionality to reduce head-of-line blocking.

The switching circuitry 130 comprises data routing circuitry 105. Each of the source ports transmits a request. The control information associated with each request is transmitted to arbitration circuitry 150. Each source port may also transmit data that is associated with the control information of a request. The arbitration circuitry 150 comprises an arbitration circuit for each of the destination ports 120a-120d. Each of the source ports 110a-110e is connected to each arbitration circuit in the arbitration circuitry 150. The arbitration circuit for a particular destination port determines, when multiple requests are presented, which of those requests is permitted to proceed. This result is used to control the data routing circuitry 105 in order to cause the data associated with the winning request (if any) to be transmitted to the destination port. Meanwhile the request itself is transmitted via the arbitration circuitry 150 to the relevant destination port.

There are a number of ways in which the arbitration circuit for a particular destination port may be implemented.

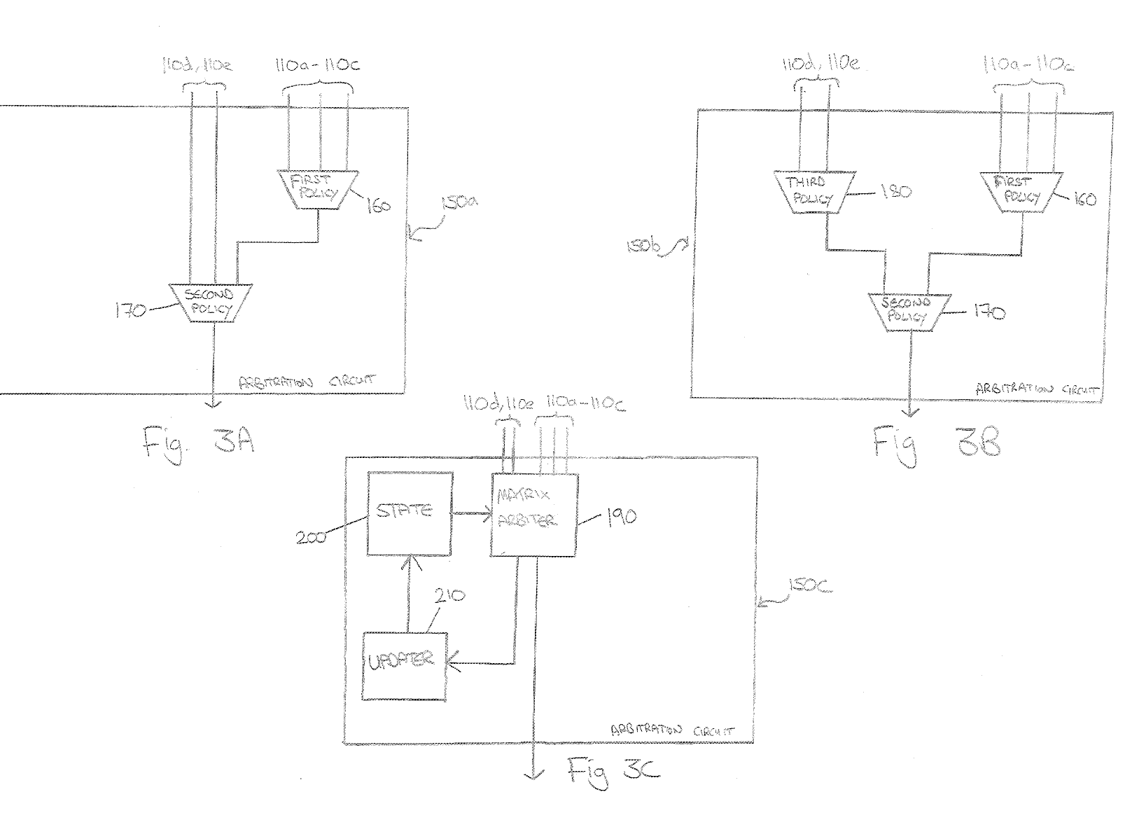

FIG. 3A shows an example of an arbitration circuit 150a associated with a single destination port in accordance with one embodiment. In the embodiment shown in FIG. 3A, a first subset of source ports 110a-110c is provided to a first arbiter 160 that applies a first arbitration policy. The winner, together with a second subset of source ports 110d and 110e is provided to a second arbiter 170 that applies a second arbitration policy. Accordingly, the first arbitration policy, which may be an exhaustive arbitration policy such as Most Recently Used (MRU), selects a winning source port from the first subset of the source ports. The winner, together with the remaining source ports 110d and 110e are then provided to the second arbiter 170 that applies a second arbitration policy such as Least Recently Used (LRU). An overall winner is then provided by the second arbiter 170 and the request presented by the winning source port is passed to the destination port associated with the arbitration circuit 150a. Note that the second arbiter 170 arbitrates in respect of requests of all of the source ports by virtue of considering a winning source port provided by the first arbiter 160 from among the first subset of source ports. In other words, each source port is considered directly by either the second arbiter or the first arbiter and the second arbiter indirectly considers the source ports presented to the first arbiter as a result of directly considering the winner from among all the source ports presented to the first arbiter.

By virtue of the first arbiter 160 using an exhaustive arbitration policy, head-of-line blocking can be inhibited, in particular, by selecting the most recently used source port from a first subset of source ports 110a-110c, the first arbiter 160 will continue to accept requests from one of those source ports as long as that source port presents requests. However, the arbitration circuit 150a is also able to deliver delay intolerant requests, such as snoop responses and coherence responses, in a timely manner. This is because such requests are able to bypass the first arbitration policy and only be considered by the second arbitration policy at the second arbiter 170. In practice, since snoop responses and coherency responses are rarely issued, then if the second arbitration policy of the second arbiter 170 is Least Recently Used (LRU) then any request presented by one of the second subset of source ports is likely to be selected in preference to the winning source port presented by the first arbiter. Hence, by bypassing the first arbitration policy, the source ports 110d and 110e are more likely to be selected if they are presenting requests. Consequently, delay intolerant requests presented by the second subset of source ports 110d, 110e are less likely to be delayed and are less likely to be delayed for an extended period of time. The arbitration circuit 150a is therefore able to handle head-of-line blocking using a small amount of circuitry and without compromising delay intolerant requests that may be issued by the second subset of source ports 110d, 110e.

FIG. 3B shows an arbitration circuit in accordance with one embodiment.

The arbitration circuit 150b is similar to that shown in FIG. 3A. However, the embodiment shown in FIG. 3B comprises a third arbiter 180 that applies a third arbitration policy. The second subset of source ports 110d, 110e is provided to the third arbiter 180, which applies the third arbitration policy to that subset of source ports in order to produce a winner. The winners presented by the third arbiter 180 and the first arbiter 160 are then provided to the second arbiter 170, which determines an overall winner for the arbitration circuit 150b. By providing the third arbiter 180, it may be possible to achieve a finer grain control over the source port that is considered to be the overall winner. In particular, the third arbiter 180 indicates how, for example, delay intolerant requests received from the second subset of source ports 110d, 110e are selected.

In the embodiments shown in FIG. 3A and FIG. 3B, a single winner is selected from the first arbiter 160 and the third arbiter 180. However, this need not be the case. In particular, either of these arbiters may output a subset of source ports, which are then provided to the second arbiter 170 to arbitrate between.

Also in the embodiments shown in FIG. 3A and FIG. 3B, the first arbiter 160 and the third arbiter 180 produce an intermediate result. In particular, the first arbitration policy is first applied to the first subset of the source ports 110a-110c and the result of applying that arbitration policy is passed onto the second arbiter 170. However, this need not be the case. In particular, in the embodiment shown in FIG. 3C, the arbitration circuit 150c comprises a matrix arbiter 190, state storing circuitry 200, and updating circuitry 210. All of the source ports 110a-110e are provided to the matrix arbiter 190. The matrix arbiter 190 consults the state storing circuitry 200 as to which source port is considered to be the winner and this is selected by the matrix arbiter 190 and output by the arbitration circuit 150c. The updating circuitry 210 is then accessed in order to update the state stored by the state control circuitry 200.

In the matrix arbiter 190, a matrix is used to represent, for the associated destination port, which source port is considered to be the winner when two source ports are attempting to send to that destination port. Accordingly, it is possible to determine, for a set of requests presented by a set of source ports, which request will be output at the associated destination port. It will be appreciated that such a matrix, if updated, can be used to represent both a first arbitration policy and a second arbitration policy (and indeed any number of arbitration policies). However, no intermediate result is produced. Instead, as a result of consulting the matrix it is possible to determine the overall winner without producing an intermediate result corresponding to the application of only one of the arbitration policies.

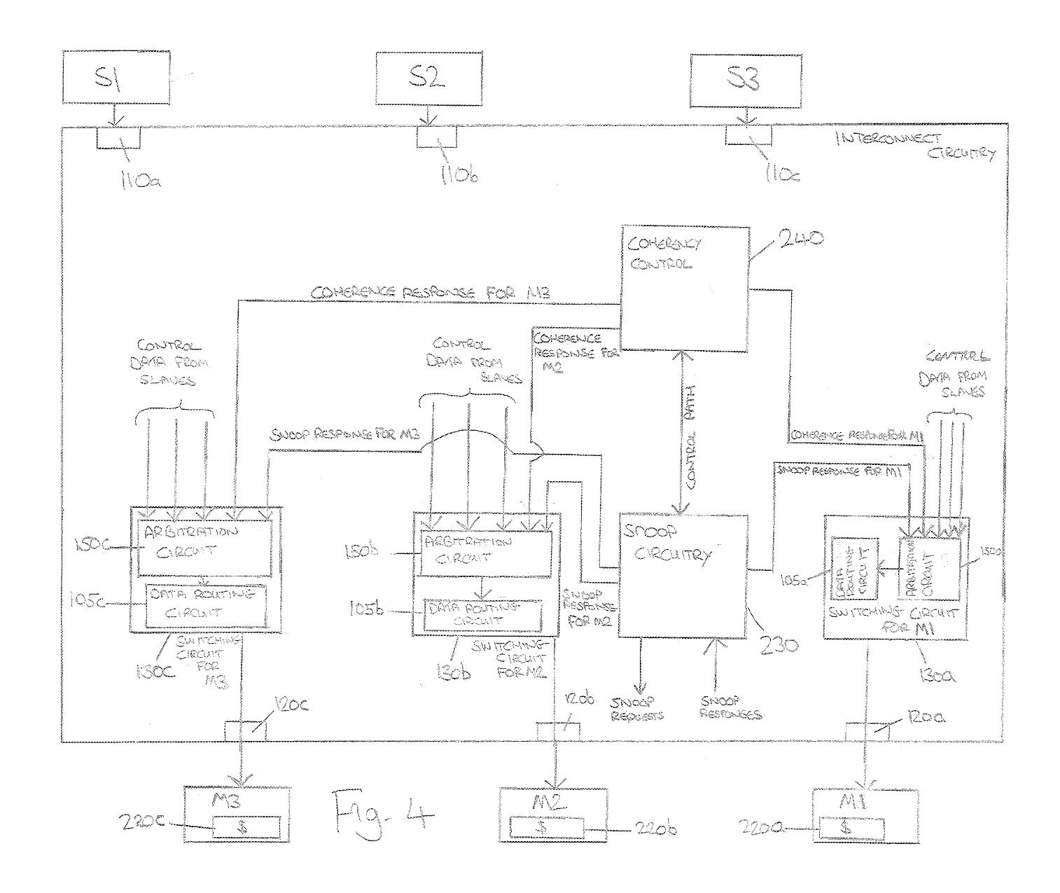

FIG. 4 illustrates interconnect circuitry in accordance with one embodiment.

The embodiment of FIG. 4 includes three slave devices S1, S2, and S3. Each of these source devices is connected to one of the source ports 110a, 110b, and 110c. Each slave device may, for example, be a memory and so the requests being issued in this embodiment may relate to requests to transmit data from memory that was sought by the master devices in a previous transaction. The embodiment shown in FIG. 4 comprises three master devices M1, M2, and M3, each of which has an associated cache 220a, 220b, and 220c. A separate switching circuit 130a, 130b, and 130c is provided for each of the masters, which are accessed via destination ports 120a, 120b, and 120c. As shown in the case of the switching circuit for M1 130a, each switching circuit comprises an arbitration circuit 150a and a data routing circuit 105a. Switching circuit 130a, switching circuit 130b and switching circuit 130c perform similar functionality to the switching circuitry 130 illustrated in the embodiment of FIG. 2, but each of them acts in respect of a single master device. Hence, separate arbitration circuits 150a, 150b, and 150c are also illustrated in the embodiment of FIG. 4 (one for each master device) and these collectively make up the arbitration circuitry 150 illustrated in the embodiment of FIG. 2. Each of the switching circuits 130a, 130b, and 130c receives requests from all of the slaves S1, S2, and S3. In particular, the arbitration circuits 150a, 150b, and 150c each receives control information from the slaves S1, S2, and S3. Although not shown in FIG. 4, the data routing circuits 105a, 105b, and 105c each receives the data corresponding to the control information from the slaves S1, S2, and S3.

When one of the masters, such as M1, requests data stored on one of the slaves S1, S2, S3, the coherency control circuitry 240 may “intercept” the request. The latest version of the requested data may be stored in a cache belonging to another master, and so it may be necessary to query some or all of the other masters in order to determine whether they have that data, and whether that data is more recent than data stored in memory (e.g. at a slave). Such a query is known as a snoop request. If a snoop request is required, then the coherency control circuitry 240 may cause the snoop circuitry 230 to generate such snoop requests which, in this example, may be generated and sent to M2 and M3. In response to the snoop requests, snoop responses may be generated by M2 and M3 which are then forwarded by the snoop circuitry 230 as requests to the arbitration circuit 150a associated with M1. As previously described, the arbitration circuits may “prioritise” such requests by use of the second arbitration policy. As previously explained, a master device may also receive requests in the form of coherence responses from the coherency control circuitry 240. For example, this may occur when the coherency control circuitry 240 determines that it is not necessary for a snoop request to be sent to a particular master and so responds itself rather than causing a snoop response to be sent to the master and for the consequent snoop response to be forwarded back.

Accordingly, each arbitration circuit 150a, 150b, and 150c receives requests from the slave devices S1, S2, S3 and may also receive snoop responses from other master devices as well as coherency responses that are generated via the coherency control circuitry 240. Since the coherency control circuitry 240 is shared between all masters M1, M2, and M3, it is highly desirable for the coherency responses to be handled quickly. In other words, both snoop responses and the coherence responses are delay intolerant. In particular, the results of issuing the snoop responses and coherence responses must take place before the system is able to proceed otherwise there is a chance that the system will lose coherency and that multiple versions of data will be stored in different parts of the system. Consequently, at the arbitration circuit, although it is desirable to inhibit head-of-line blocking, it is necessary to handle the snoop responses and coherence responses quickly. By using an arbitration circuit as outlined in the embodiment shown in FIGS. 3a, 3b, and 3c, it is possible to inhibit head-of-line blocking, while responding to delay intolerant requests.

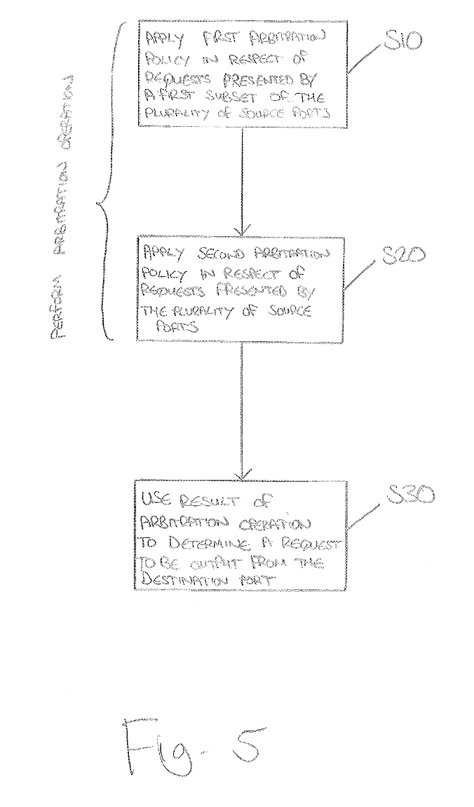

FIG. 5 illustrates, in flow chart form, a method of switching in accordance with one embodiment.

At step S10, a first arbitration policy is applied in respect of request presented by a first subset of the plurality of source ports. At step S20, a second arbitration policy is applied in respect of requests presented by the plurality of source ports. Collectively, step S10 and S20 comprise an arbitration operation that may be carried out in a single step or may be carried out in such a manner that intermediate results are produced. In either case, at step S30, the result of the arbitration operation is used in order to determine which request presented at the same ports is to be output by the destination port.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
switching circuitry comprising a plurality of source ports and a plurality of destination ports; and
arbitration circuitry to perform an arbitration operation on a plurality of requests presented at said plurality of source ports in order to determine for at least one of said destination ports one of said requests to be output from that destination port, wherein said arbitration operation comprises applying a first arbitration policy respect of requests presented by a first subset of said plurality of source ports, and a second arbitration policy in respect of requests presented by said plurality of source ports, wherein
said first arbitration policy is to reduce head-of-line blocking compared to said second arbitration policy.

2. An apparatus according to claim 1, wherein
said plurality of source ports comprise a second subset, and said arbitration circuitry applies said arbitration operation without applying said first arbitration policy to requests presented by said second subset.

3. An apparatus according to claim 2, wherein
said second arbitration policy is to reduce a latency of requests presented by said second subset of said plurality of source ports compared to requests presented by said first subset of said plurality of source ports.

4. An apparatus according to claim 1, wherein
said second arbitration policy is selected from a group comprising: Least Recently Used, Round Robin, and Weighted Round Robin, Pseudo Least Recently Used, and Oblivious Fair.

5. An apparatus according to claim 1, wherein
said arbitration circuitry applies said first arbitration policy to produce third subset of said plurality of source ports, wherein said third subset is a subset of said first subset; and
said arbitration circuitry applies said second arbitration policy in respect of requests presented by said third subset of said plurality of source ports and in respect of requests presented by said second subset of said plurality of source ports.

6. An apparatus according to claim 5, wherein
said third subset consists of a single source port.

7. An apparatus according to claim 1, wherein
said first arbitration policy is exhaustive.

8. An apparatus according to claim 7, wherein
in response to a timeout, said first arbitration policy switches to being non-exhaustive until a predefined condition is met.

9. An apparatus according to claim 1, wherein
said first arbitration policy gives priority to said most recently used source port.

10. An apparatus according to claim 1, wherein
if no request is presented at a most recently used source port, said first arbitration policy selects a source port fairly.

11. An apparatus according to claim 1, wherein
said first arbitration policy selects a source port fairly by using a policy from a group comprising: Most Recently Used, Pseudo Most Recently Used, Least Recently Used, Round Robin, and Weighted Round Robin, Pseudo Least Recently Used and Oblivious Fair.

12. An apparatus according to claim 2, wherein
said arbitration circuitry applies a third arbitration policy to produce a fourth subset of said plurality of source pods, wherein said fourth subset is a subset of said second subset; and
said arbitration circuitry applies said second arbitration policy in respect of requests presented by said fourth subset of said plurality of source ports and in respect of requests presented by said first subset of said plurality of source ports.

13. An apparatus according to claim 1, wherein
said arbitration circuitry applies said second arbitration policy to a request presented by exactly one source port in said first subset and to a request presented by exactly one source pod outside said first subset.

14. An apparatus according to claim 1, wherein
said arbitration circuitry performs said arbitration operation using a matrix arbiter.

15. An apparatus according to claim 1, wherein
said arbitration circuitry comprises a first arbiter to apply said first arbitration policy and a second arbiter to apply said second arbitration policy.

16. An apparatus comprising:
switching means for performing switching between a plurality of source ports and a plurality of destination ports;
arbitration means for performing an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein
said first arbitration policy is to reduce head-of-line blocking compare to said second arbitration policy.

17. A method of arbitrating at a switching circuitry comprising a plurality of source ports and a plurality of destination ports, said method comprising:
performing an arbitration operation on a plurality of requests presented at said plurality of source ports in order to determine for at least one of said destination ports one of said requests to be output from that destination port, wherein said arbitration operation comprises applying a first arbitration policy in respect of requests presented by a first subset of said plurality of source ports, and a second arbitration policy in respect of requests presented by said plurality of source ports, wherein
said first arbitration policy is to reduce head-of-line blocking compared to said second arbitration policy.
